(19) United States
(12) Patent Application Publication
(10) Pub. No.: US 2021/0374856 A1
(43) Pub. Date: Dec. 2, 2021

(54) COMPUTER-READABLE RECORDING MEDIUM STORING TRADING PROGRAM, TRADING METHOD AND TRADING DEVICE

(71) Applicant: FUJITSU LIMITED, Kawasaki-shi (JP)

(72) Inventors: Toshihiro Shimizu, Kawasaki (JP); Takumi Honda, Kawasaki (JP); Akihito Nakamura, Shinagawa (JP); Motohiro KOSAKI, Kawasaki (JP); Akihiro Kuwabara, Meguro (JP)

(73) Assignee: FUJITSU LIMITED, Kawasaki-shi (JP)

(21) Appl. No.: 17/402,661

(22) Filed: Aug. 16, 2021

Related U.S. Application Data
(63) Continuation of application No. PCT/JP2019/009197, filed on Mar. 7, 2019.

(51) Int. Cl. G06Q 40/04

(52) U.S. Cl. CPC G06Q 40/04

(57) ABSTRACT

A non-transitory computer-readable recording medium stores a trading program far causing a computer to execute a process including: acquiring a number of sell orders for each of sell limits and a number of buy orders for each of buy limits; executing one of pairings of one of the sell orders and one of the buy orders in which one of the sell limits of the one of the sell orders is equal to or lower than one of the buy limits of the one of the buy orders, among the pairings of the sell orders and the buy orders, based on the acquired number of the sell orders for each of the sell limits and the acquired number of the buy orders for each of the buy limits; and resolving an execution price for each of executions.

### CROSS-REFERENCE TO RELATED APPLICATION

This application is a continuation application of International Application PCT/JP2019/009197 filed on Mar. 7, 2019 and designated the U.S., the entire contents of which are incorporated herein by reference.

### FIELD

The embodiments discussed herein are related to a trading program, a trading method, and a trading device.

### BACKGROUND

In the trading of stocks or the like, Itayose and Zaraba are employed. Itayose is a trade in which orders from the time the orders are accepted to the start of transactions are put together, and the opening price is resolved by establishing the transactions. Zaraba is a trade in which a transaction is established between an already placed order and a newly placed order, or between newly placed orders.

Japanese Laid-open Patent Publication No. 2011-150652, Japanese Laid-open Patent Publication No. 2011-215908, and Japanese National Publication of International Patent Application No. 2004-537076 are disclosed as related art.

### SUMMARY

According to an aspect of the embodiments, a non-transitory computer-readable recording medium stores a trading program for causing a computer to execute a process including: acquiring a number of sell orders for each of sell limits and a number of buy orders for each of buy limits; executing one of pairings of one of the sell orders and one of the buy orders in which one of the sell limits of the one of the sell orders is equal to or lower than one of the buy limits of the one of the buy orders, among the pairings of the sell orders and the buy orders, based on the acquired number of the sell orders for each of the sell limits and the acquired number of the buy orders for each of the buy limits; and resolving an execution price for each of executions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of Itayose by an execution device according to a first embodiment;

FIG. 2 is a diagram illustrating an example of setting execution prices of the executions illustrated in FIG. 1;

FIG. 3 is a diagram illustrating an example of setting a stock price subsequent to the executions illustrated in FIG. 1;

FIG. 4 is a diagram illustrating a configuration of a trading system according to the first embodiment;

FIG. 5 is a flowchart illustrating a flow of processing by the execution device;

FIG. 6 is a diagram illustrating an example of matching by a first matching method;

FIG. 7 is a flowchart illustrating a flow of processing by the first matching method;

FIG. 8 is a diagram illustrating an example of executions by a second matching method;

FIG. 9 is a flowchart illustrating a flow of processing by the second matching method;

FIG. 10 is a diagram for explaining a third matching method;

FIG. 11 is a flowchart illustrating a flow of processing by the third matching method;

FIG. 12 is a diagram illustrating an example of a mating rule;

FIG. 13 is a flowchart illustrating a flow of processing by a fourth matching method;

FIG. 14A is a diagram for explaining a maximum flow problem for a network flow;

FIG. 14B is a diagram for explaining the formulation of a depth of market table as a network flow;

FIG. 14C is a diagram illustrating the maximum flow o he network flow illustrated in FIG. 14B;

FIG. 15 is a flowchart illustrating a flow of processing by a fifth matching method;

FIG. 16 is a diagram illustrating an example of replacing an order with an unfavorable price with an order with a more favorable price;

FIG. 17 is a diagram illustrating an example in which buy orders are shifted to k from the highest one;

FIG. 18 is a diagram for explaining the removal of an intersection;

FIG. 19A is a flowchart illustrating a flow of processing in which a matching unit according to a second embodiment specifies the maximum number of executions;

FIG. 19B is a flowchart illustrating a flow of processing in which it is determined whether or not m executions are possible;

FIG. 20 is a diagram for explaining a bipartite graph representation of stock trading;

FIG. 21 is a diagram for explaining a method of specifying a maximum number of executions k;

FIG. 22 is a diagram illustrating maximum matching that meets a priority;

FIG. 23 is a diagram for explaining a method of specifying the maximum number of executions k;

FIG. 24 is a diagram illustrating maximum matching that meets a priority;

FIG. 25 is a flowchart illustrating a flow of processing by a matching unit according to a third embodiment;

FIG. 26 is a diagram illustrating an example of processing time by the matching units according to the first to third embodiments;

FIG. 27 is a diagram illustrating a hardware configuration of a computer that executes an execution program according to an embodiment;

FIG. 28 is a diagram illustrating an example of depth of market information in stock trading; and

FIG. 29 is a diagram for explaining Itayose stock trading.

### DESCRIPTION OF EMBODIMENTS

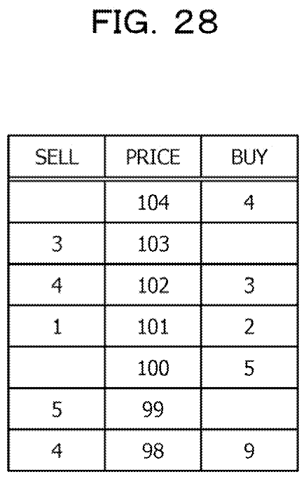

For the trade, depth of market information that indicates the sell limits of sell orders and the number of sell orders and the buy limits of buy orders and the number of buy orders is used. FIG. 28 is a diagram illustrating an example of the depth of market information in stock trading. In FIG. 28, the middle column indicates the value of the limit price, the left column indicates the number of shares of sell orders relevant to the price, and the right column indicates the number of shares of buy orders relevant to the price. Here, one share denotes the unit number of stocks. For example, the number of shares of sell orders with a sell limit of 102 yen is four, and the number of shares of buy orders with a buy limit of 102 yen is three.

In Itayose stock trading, an execution device executes the sell orders and the buy orders sequentially in the order from the lowest for sell orders and in the order from the highest for buy orders. Then, the execution device stops the execution at a point where the sell order and the buy order have the same price and designates the price at that time as the present price. Thereafter, all the executed trades are equally performed at the present price.

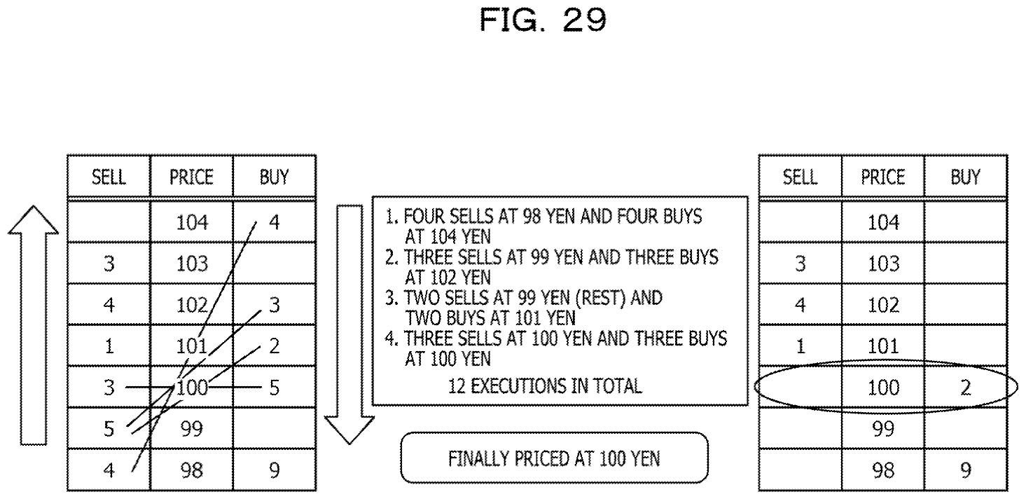

FIG. 29 is a diagram for explaining Itayose stock trading. As illustrated in FIG. 29, the execution device first executes four sells of 98 yen and four buys of 104 yen. Next, the execution device executes three sells of 99 yen and three buys of 102 yen. Next, the execution device executes two sells of 99 yen and two buys of 101 yen. Then, the execution device executes three sells of 100 yen and three buys of 100 yen and ends the execution. In this case, the execution device executes a total of 12 deals at 100 yen and designates the present price as 100 yen.

Note that, as prior art, there is a trading system that improves the convenience of investors and reduces the load on the system in an auction trading market. This trading system includes an order information database, an auction market price reporting interface, a price information database, a price information management unit, and an order information management unit.

The order information database stores order data in which trading participant identification information, the brand of a financial product, the order quantity, and the transaction category are defined. The auction market price reporting interface receives market price information in which the brand, the execution price, and the quantity of a financial product executed in the auction trading market are described, from an auction trading market system that manages the trade of the financial product in the auction trading market. The price information database accumulates the market price information received by the auction market price reporting interface.

Every time the market price information is received, the price information management unit calculates the volume-weighted average price of the financial product of the brand described in the received market price information, based on the price information database. Then, the price information management unit determines whether or not one of a first price relationship and a second relationship is established. Here, the first relationship is a relationship in which the volume-weighted average price calculated this time is smaller than the execution price described in the market price information received this time, and the volume-weighted average price calculated last time is larger than the execution price described in the market price information received last time. The second relationship is a relationship in which the volume-weighted average price calculated this time is larger than the execution price described in the market price information received this time, and the volume-weighted average price calculated last time is smaller than the execution price described in the market price information received last time.

Then, the order information management unit conducts execution processing on order data in which a brand for which the first price relationship or the second price relationship is established in the order information database is defined, and sets the trading price of the executed order data to the same price as the execution price described in the market price information received this time.

Furthermore, as prior art, there is an algorithmic trading system that deals with huge combinations of algorithm elements used for dynamic algorithmic trading and performs online trading. This algorithmic trading system includes an individual simulation execution part, a control part, a sorting part, and an order placing part.

The individual simulation execution part obtains an execution result for one temporal span by executing an individual simulation of the trading with one algorithm element from a batch of algorithm elements. The control part controls the individual simulation execution part so as to apply each algorithm element of the batch of algorithm elements entirely to each of temporal spans of trading of one day and perform an individual simulation a number of times corresponding to the product of the number of temporal spans and the number of algorithm elements.

The sorting part sorts out the best combination of algorithm elements based on the execution results per temporal span obtained from the individual simulation execution part controlled by the control part. The order placing part places an online order with the best combination of algorithm elements sorted out by the sorting part.

Furthermore, as prior art, there is a system for facilitating the trading of two items from a group of items constituted by products and financial products. This system is constituted by at least two agents wishing to trade an item, a trading channel between the two agents that allows the execution of the trading, flow constraints, and a central computer. The flow constraints include flow constraints for traded items and flow constraints for a particular underlying product that is supposed to be exchanged at the time of checkout of the traded item. The central computer is linked to the two agents and notifies each agent of the prices and sizes with the currently tradable bid and ask prices in line with the agents' flow constraints.

In Itayose illustrated in FIG. 29, sell orders higher than the present price, buy orders lower than the present price, and either the sell order at the present price or the buy order at the present price are put on hold without being settled. There is thus a problem that the orders put on hold remain on the depth of market table and the number of executions is small.

One aspect of the present embodiment aims to increase the number of executions in Itayose.

Hereinafter, embodiments will be described of a trading program, a trading method, and a trading device disclosed in the present application in detail with reference to the drawings. Note that the embodiments do not limit the technology disclosed.

### First Embodiment

First, an Itayose approach by an execution device according to a first embodiment will be described. The execution device according to the first embodiment makes an execution regardless of the present price if the limit price or a price more favorable to an investor than the limit price is given. Here, the favorable price for the investor is a price higher than the sell limit in the case of a sell order and a price lower than the buy limit in the case of a buy order.

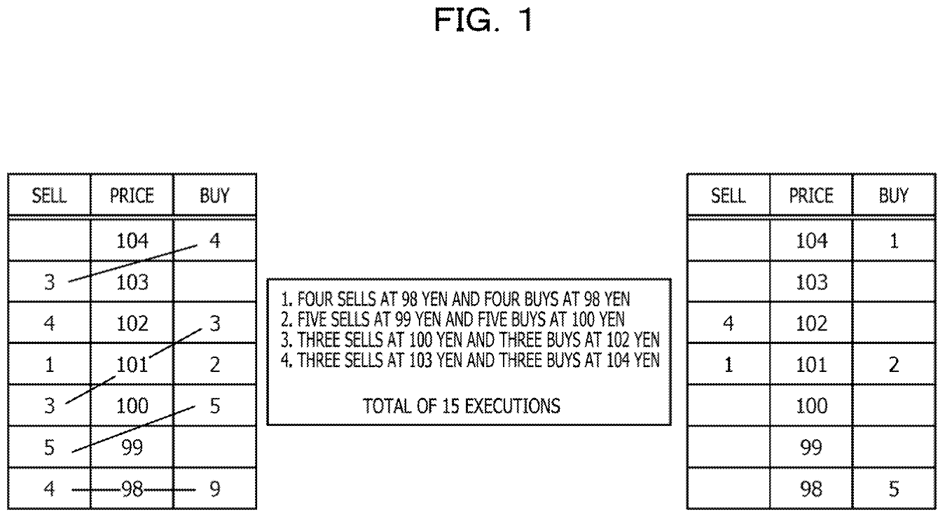

FIG. 1 is a diagram illustrating an example of Itayose by the execution device according to the first embodiment. As illustrated in FIG. 1, the execution device according to the first embodiment executes a total of 15 deals made up of four sells at 98 yen and four buys at 98 yen, five sells at 99 yen and five buys at 100 yen, and three sells at 100 yen and three buys at 102 yen, and three sells at 103 yen and three buys at 104 yen. Compared with the case illustrate in FIG. 29, the Itayose approach using the execution device according to the first embodiment increases the number of executions by three.

In this manner, in Itayose by the execution device according to the first embodiment, since a degree of freedom is produced in which sell order and which buy order are to be executed, it becomes possible to select an execution approach such as maximizing the number of executions or minimizing the execution price gap. Furthermore, in Itayose by the execution device according to the first embodiment, the execution price can be set to any value equal to or higher than the sell limit but equal to or lower than the buy limit. For example, assuming that the sell limit is s yen, the buy limit is b (s≤b) yen, and the present price is p yen, the execution device according to the first embodiment designates the execution price also as p yen if p is contained in the interval [s, b], and designates the execution price as a value closest to p yen if p is not contained in the interval [s, b]. For example, in the execution device according to the first embodiment, if p<s holds, the execution price is designated as s yen, and if b<p holds, the execution price is designated as b yen.

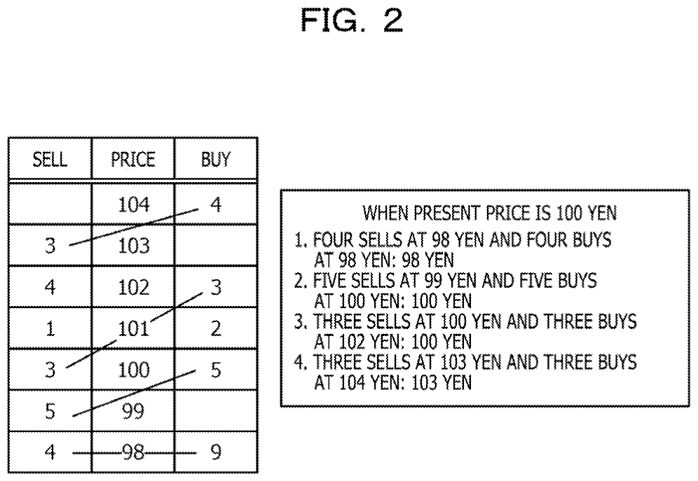

FIG. 2 is a diagram illustrating an example of setting the execution prices of the executions illustrated in FIG. 1. As illustrated in FIG. 2, the execution price of four sells at 98 yen and four buys at 98 yen is 98 yen because s=98 and b=98<p=100 hold, and the execution price of five sells at 99 yen and five buys at 100 yen is 100 yen because s=99 and b=100=p hold. Furthermore, the execution price of three sells at 100 yen and three buys at 102 yen is 100 yen because s=100=p and b=102 hold, and the execution price of three sells at 103 yen and three buys at 104 yen is 103 yen because p<s=103 and b=104 hold.

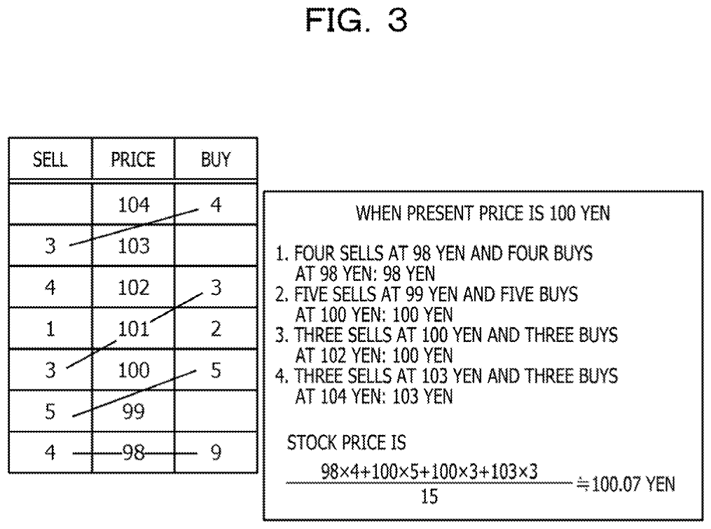

In addition, the execution device according to the first embodiment designates an average value of all the execution prices as the subsequent stock price. FIG. 3 is a diagram illustrating an example of setting a stock price subsequent to the executions illustrated in FIG. 1. As illustrated in FIG. 3, the subsequent stock price is (98×4+100×5+100×3+103×3)/15≈100.07 yen.

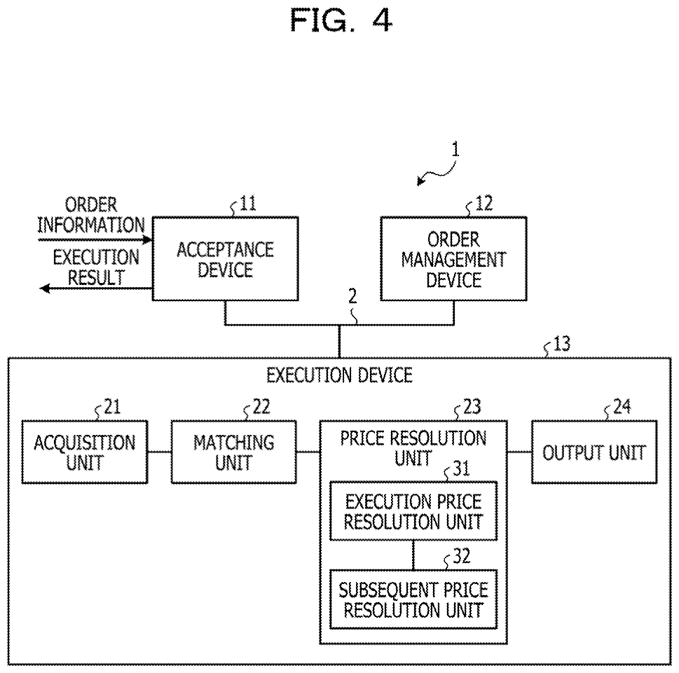

Next, a configuration of the trading system according to the first embodiment will be described. FIG. 4 is a diagram illustrating a configuration of the trading system according to the first embodiment. As illustrated in FIG. 4, a trading system 1 according to the first embodiment includes an acceptance device 11, an order management device 12, and an execution device 13. The acceptance device 11, the order management device 12, and the execution device 13 are connected by an internal network 2.

The acceptance device 11 accepts order information and transmits the accepted order information to the order management device 12. For example, the order information contains an orderer identifier that identifies the orderer, a brand, a distinction between buying and selling, a limit price, the number of stocks, and the like. The acceptance device 11 receives, for example, the order information transmitted from an information processing device via an external network. The information processing device, for example, transmits the order information based on an order input by an investor using a mouse or a keyboard.

Furthermore, the acceptance device 11 receives an execution result from the order management device 12 and transmits the received execution result to the information processing device. For example, the execution result contains an orderer identifier, a brand, a distinction between buying and selling, an execution price, the number of executed stocks, and the like. The acceptance device 11 transmits the execution result to the information processing device from which the order information was transmitted, for example, using an Internet protocol (IP) address associated with the orderer identifier.

The order management device 12 manages the order information by appending, for example, an order identifier that identifies the order. The order management device 12 stores all the order information accepted by the acceptance device 11 before the start of Itayose and, at the start of Itayose, transmits the sell limit and the number of sell orders, and the buy limit and the number of buy orders to the execution device 13 for each brand.

Furthermore, the order management device 12 receives execution information for each brand from the execution device 13 and updates the order information. In addition, the order management device 12 creates an execution result based on the execution information and transmits the created execution result to the acceptance device 11. For example, the execution information contains a sell limit, a buy limit, an execution price, the number of executed stocks, and the like for one or more executions.

In Itayose, the execution device 13 receives information on sell orders and buy orders for each brand from the order management device 12 via the internal network 2 and executes the sell orders and the buy orders to resolve the execution price and the subsequent stock price. Each piece of the information on sell orders contains the sell limit and the number of sell orders, and each piece of the information on buy orders contains the buy limit and the number of buy orders. Furthermore, the execution device 13 transmits the execution information to the order management device 12 for each brand via the internal network 2.

The execution device 13 includes an acquisition unit 21, a matching unit 22, a price resolution unit 23, and an output unit 24. The acquisition unit 21 receives information on sell orders and buy orders for each brand from the order management device 12 via the internal network 2.

The matching unit 22 matches the sell orders and the buy orders for each brand. The matching unit 22 performs matching regardless of the present price if the limit price or a price more favorable to the investor than the limit price is given. Note that the details of the matching method by the matching unit 22 will be described later.

Based on the matching by the matching unit 22, the price resolution unit 23 resolves the execution price per match and the subsequent stock price per brand. The price resolution unit 23 includes an execution price resolution unit 31 and a subsequent price resolution unit 32.

Assuming that the sell limit is s yen, the buy limit is b (s≤b) yen, and the present price is p yen, the execution price resolution unit 31 designates the execution price also as p yen when p is contained in the interval [s, b]. On the other hand, when p is not contained in the interval [s, b], the execution price resolution unit 31 designates the execution price as a value closest to p yen, which means to designate the execution price as s yen if p<s holds, and to designate the execution price as b yen If b<p holds.

The subsequent price resolution unit 32 resolves the subsequent stock price based on the execution price resolved by the execution price resolution unit 31. For example, the subsequent price resolution unit 32 designates an average value of all the execution prices as the subsequent stock price.

The output unit 24 transmits the execution information to the order management device 12 via the internal network 2 for each brand.

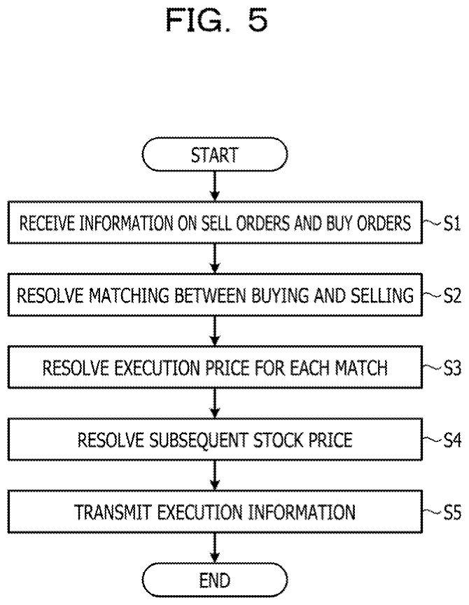

Next, a flow of processing by the execution device 13 will be described. FIG. 5 is a flowchart illustrating a flow of processing by the execution device 13. Note that the execution device 13 performs the processing illustrated in FIG. 5 for each brand. As illustrated in FIG. 5, the execution device 13 receives information on sell orders and buy orders from the order management device 12 at the start of Itayose (step S1).

Then, the execution device 13 resolves the matching between buying and selling (step S2). The execution device 13 performs matching regardless of the present price if the limit price or a price more favorable to the investor than the limit price is given. Then, the execution device 13 resolves the execution price for each match (step S3) and resolves the subsequent stock price (step S4). Then, the execution device 13 transmits the execution information to the order management device 12 (step S5).

In this manner, the execution device 13 performs matching between buying and selling regardless of the present price if the limit price or a price more favorable to the investor than the limit price is given, and resolves the execution price for each match. Consequently, the number of executions may be increased.

Next, the details of the matching method by the matching unit 22 will be described. The matching unit 22 matches sell orders and buy orders using one matching method from the following five matching methods. In the first matching method, the matching unit 22 performs matching by a full search.

For example, the matching unit 22 creates a list A of j sell orders and a list B of j buy orders. Then, the matching unit 22 selects one combination between the j orders of A and the j orders of B and performs recording processing of recording a combination in which the sell limit is equal to or lower than the buy limit for all the j orders, as a matching candidate. The matching unit 22 executes this recording processing on all combinations between j orders of A and j orders of B while switching the combinations. Moreover, the matching unit 22 executes this recording processing on all combinations between A and B while altering A or B. Additionally, the matching unit 22 performs this recording processing while changing the number of matched orders j from one to u. Here, u denotes a smaller one of the number of sell orders and the number of buy orders.

Then, the matching unit 22 selects optimum matching from among the matching candidates. Here, for example, the optimum matching means that the average of sell limits is the lowest, the average of buy limits is the highest, the number of matches is the largest, there are fewer matches within the same securities company, and the like.

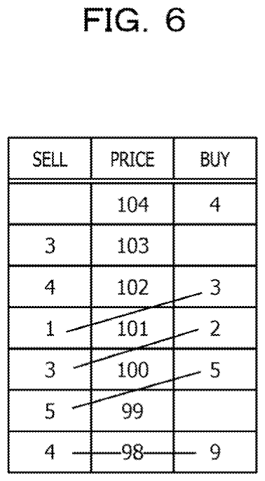

FIG. 6 is a diagram illustrating an example of matching by the first matching method. In FIG. 6, j=12 is employed. In FIG. 6, four sell orders of 98 yen and four buy orders of 98 yen, five sell orders of 99 yen and five buy orders of 100 yen, two sell orders of 100 yen and two buy orders of 101 yen, and one sell order of 101 yen and one buy order of 102 yen are regarded as one matching candidate.

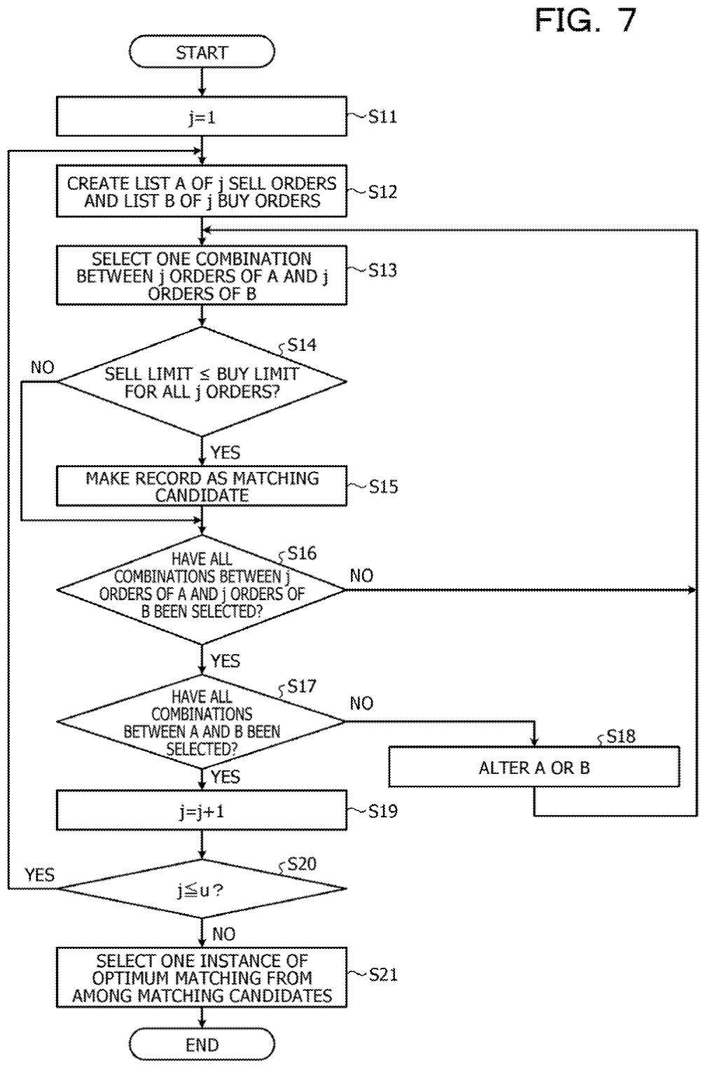

FIG. 7 is a flowchart illustrating a flow of processing by the first matching method. As illustrated in FIG. 7, the matching unit 22 designates j as one (step S11) and creates a list A of j sell orders and a list B of j buy orders (step S12). Then, the matching unit 22 selects one combination between the j orders of A and the j orders of B (step S13) and determines whether or not the sell limit is equal to or lower than the buy limit for all the j orders (step S14). Thereafter, the matching unit 22 records the selected combination as a matching candidate when the sell limit is equal to or lower than the buy limit for all the j orders (step S15).

Following the above, the matching unit 22 determines whether or not all combinations between the j orders of A and the j orders of B have been selected (step S16) and, when there is a combination that has not been selected, returns to step S13. On the other hand, when all combinations have been selected, the matching unit 22 determines whether or not all combinations between A and B have been selected (step S17) and, when there is a combination between A and B that has not been selected, alters A or B (step S18) to return to step S13.

On the other hand, when all combinations between A and B have been selected, the matching unit 22 adds one to j (step S19) and determines whether or not j is equal to or less than u (step S20). Then, when j is equal to or less than u, the matching unit 22 returns to step S12 and, when j is not equal to or less than u, selects one instance of optimum matching from among the matching candidates (step S21).

In this manner, the matching unit 22 may specify matching candidates by performing matching by a full search.

In the second matching method, the matching unit 22 executes sell orders and buy orders by performing matching by random selection. For example, the matching unit 22 creates a list A of j sell orders and a list B of j buy orders. Then, the matching unit 22 randomly selects one order from each of A and B at a time to determine whether or not the sell limit is equal to or lower than the buy limit and performs the recording processing of recording a combination in which the sell limit is equal to or lower than the buy limit for all the j orders of A and B, as a matching candidate. The matching unit 22 executes this recording processing on all combinations between A and B while altering A or B. Additionally, the matching unit 22 performs this recording processing while changing the number of matched orders j from one to u. Then, the matching unit 22 selects optimum matching from among the matching candidates.

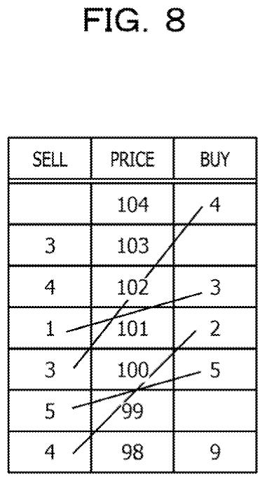

FIG. 8 is a diagram illustrating an example of executions by the second matching method, In FIG. 8, j=11 is employed. In FIG. 8, two sell orders of 98 yen and two buy orders of 101 yen, five sell orders of 99 yen and five buy orders of 100 yen, three sell orders of 100 yen and three buy orders of 104 yen, and one sell order of 101 yen and one buy order of 102 yen are regarded as one matching candidate.

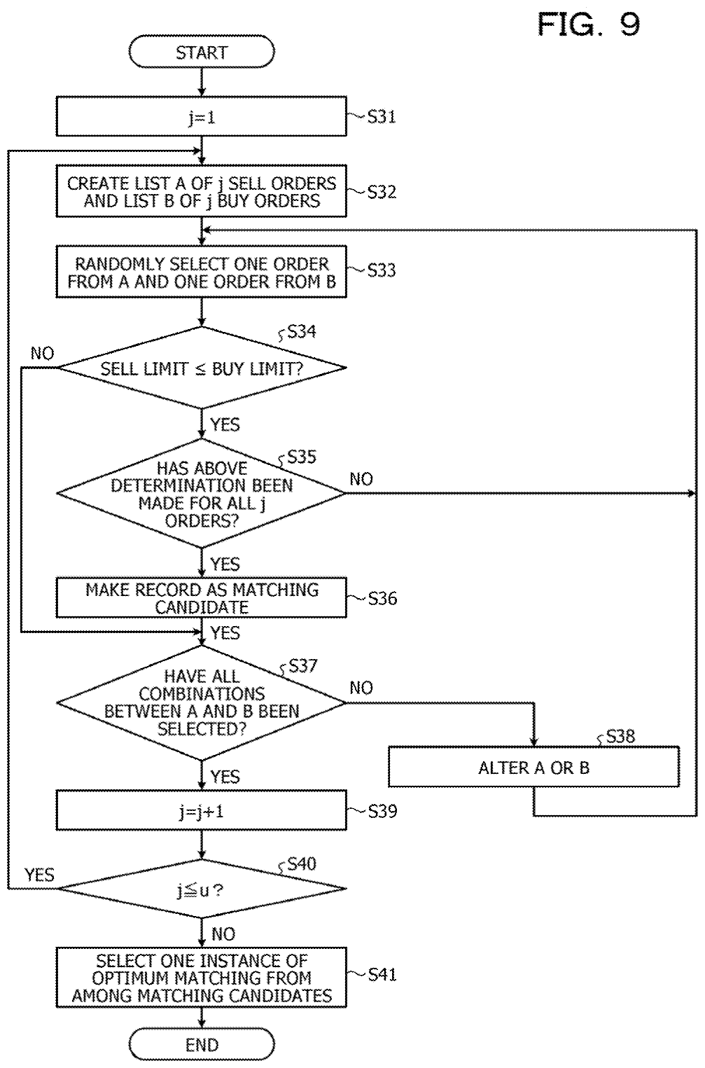

FIG. 9 is a flowchart illustrating a flow of processing by the second matching method. As illustrated in FIG. 9, the matching unit 22 designates j as one (step S31) and creates a list A of j sell orders and a list B of j buy orders (step S32). Then, the matching unit 22 randomly selects one order from A and one order from B (step S33) and determines whether or not the sell limit is equal to or lower than the buy limit (step S34). Note that the matching unit 22 deletes the selected single orders from A and B.

Then, when the sell limit is not equal to or lower than the buy limit, the matching unit 22 proceeds to step S37 and, when the sell limit is equal to or lower than the buy limit, determines whether or not the determination has been made for all the j orders (step S35). Thereafter, when A and B have a sell order and a buy order for which the determination has not been made, respectively, the matching unit 22 returns to step S33 and, when the determination has been made for all the j orders, records the combination of the randomly selected j orders as a matching candidate (step S36).

Following the above, the matching unit 22 determines whether or not all combinations between A and B have been selected (step S37) and, when there is a combination between A and B that has not been selected, alters A or B (step S38) to return to step S33.

On the other hand, when all combinations between A and B have been selected, the matching unit 22 adds one to j (step S39) and determines whether or not j is equal to or less than u (step S40). Then, when j is equal to or less than u, the matching unit 22 returns to step S32 and, when j is not equal to or less than u, selects one instance of optimum matching from among the matching candidates (step S41).

In this manner, the matching unit 22 may specify matching candidates by performing matching by random selection.

In the third matching method, the matching unit 22 performs matching by a branch and bound method. For example, the matching unit 22 performs a depth-first search in matching sell orders and buy orders and, when determining at a certain search point that optimum matching will not be obtained even if a deeper search is performed, does not perform a deeper search.

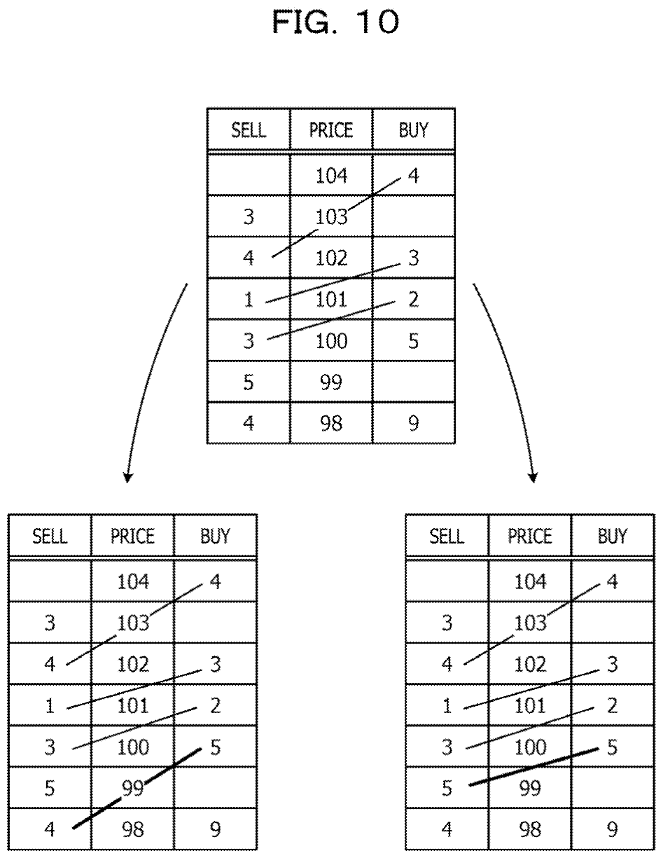

FIG. 10 is a diagram for explaining the third matching method. In FIG. 10, the matching unit 22 performs searches for four sell orders of 102 yen and four buy orders of 104 yen, one sell order of 101 yen and one buy order of 102 yen, and two sell orders of 100 yen and two buy orders of 101 yen in this order. Then, when subsequently performing searches for four sell orders of 98 yen and four buy orders of 100 yen, the matching unit 22 determines that optimum matching will not be obtained even if a deeper search is performed and deletes the four sell orders of 98 yen and the four buy orders of 100 yen. Thereafter, the subsequent search is performed from five sell orders of 99 yen and five buy orders of 100 yen.

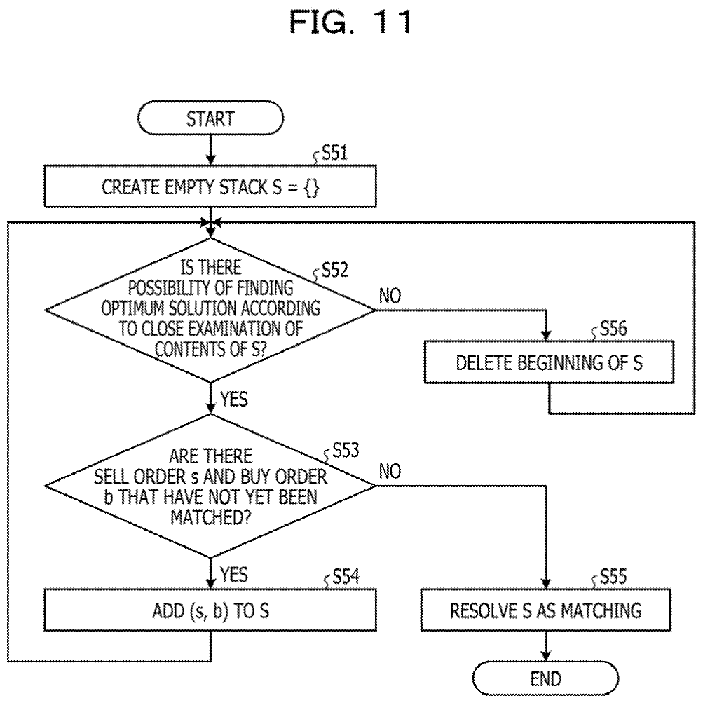

FIG. 11 is a flowchart illustrating a flow of processing by the third matching method. As illustrated in FIG. 11, the matching unit 22 creates an empty stack S={ } (step S51) and examines the contents of S closely to determine whether or not there is the possibility of finding the optimum solution (step S52).

Then, when it is determined that there is the possibility of finding the optimum solution, the matching unit 22 determines whether or not there are a sell order s and buy order b that have not yet been matched (step S53) and, when there are the sell order s and the buy order b, adds (s, b) to S (step S54) to return to step S52. On the other hand, when there is no sell order s and buy order b that have not been matched yet, the matching unit 22 resolves S as matching (step S55).

Furthermore, when it is determined in step S52 that there is no possibility of finding the optimum solution, the matching unit 22 deletes the beginning of S (step S56) to return to step S52.

In this manner, the matching unit 22 may enhance the search efficiency by pruning.

In the fourth matching method, the matching unit 22 uses a genetic algorithm to match sell orders and buy orders. For example, the matching unit 22 assigns a mating rule for two matching plans beforehand and mates the two matching plans according to the mating rule to prepare a subsequent-generation matching plan. The matching unit 22 creates a better matching plan by repeating the creation of the subsequent-generation matching plan. The matching unit 22 creates, for example, matching plans for several thousands of generations.

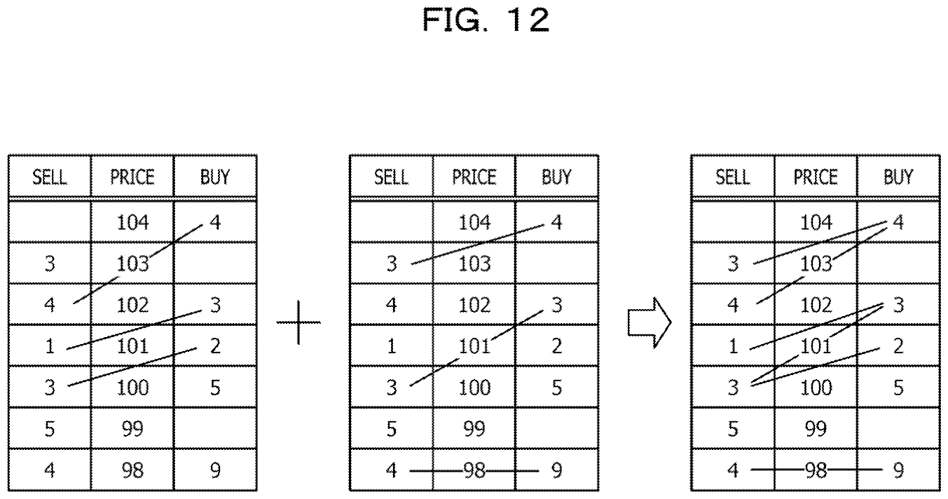

FIG. 12 is a diagram illustrating an example of the mating rule. As illustrated in FIG. 12, the matching unit 22 prepares the subsequent-generation matching plan by joining up two matching plans. However, when conflict occurs in matching by joining up the two matching plans, the matching unit 22 makes adjustments. For example, in FIG. 12, mating produces conflict between a match between four sell orders of 102 yen and four buy orders of 104 yen and a match between three sell orders of 103 yen and three buy orders of 104 yen. In such a case, for example, the matching unit 22 makes adjustments such as decreasing the number of orders of each match so as to suppress conflict.

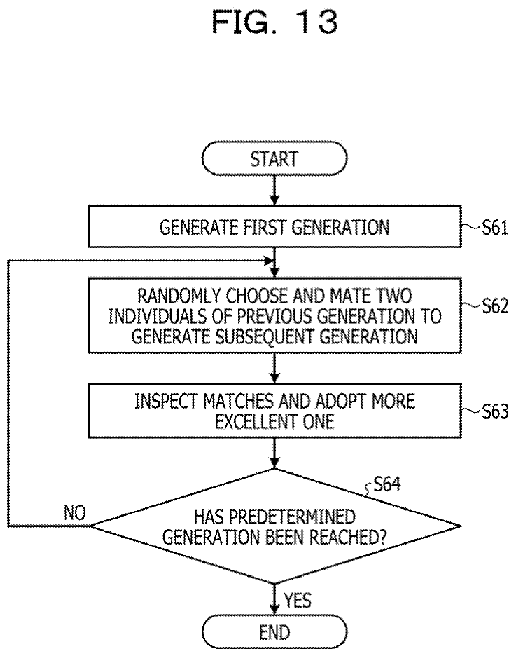

FIG. 13 is a flowchart illustrating a flow of processing by the fourth matching method. As illustrated in FIG. 13, the matching unit 22 generates a first generation (step S61). For example, the matching unit 22 generates a fixed number of matches between single sells and single buys to designate the generated matches as the first generation.

Then, the matching unit 22 randomly chooses and mates two individuals of the previous generation to generate a subsequent generation (step S62). Thereafter, the matching unit 22 inspects the matches and adopts a more excellent one (step S63). Following the above, the matching unit 22 determines whether or not a predetermined generation has been reached (step S64) and returns to step S62 when the predetermined generation has not been reached, while designating the predetermined generation as a matching result when the predetermined generation has been reached.

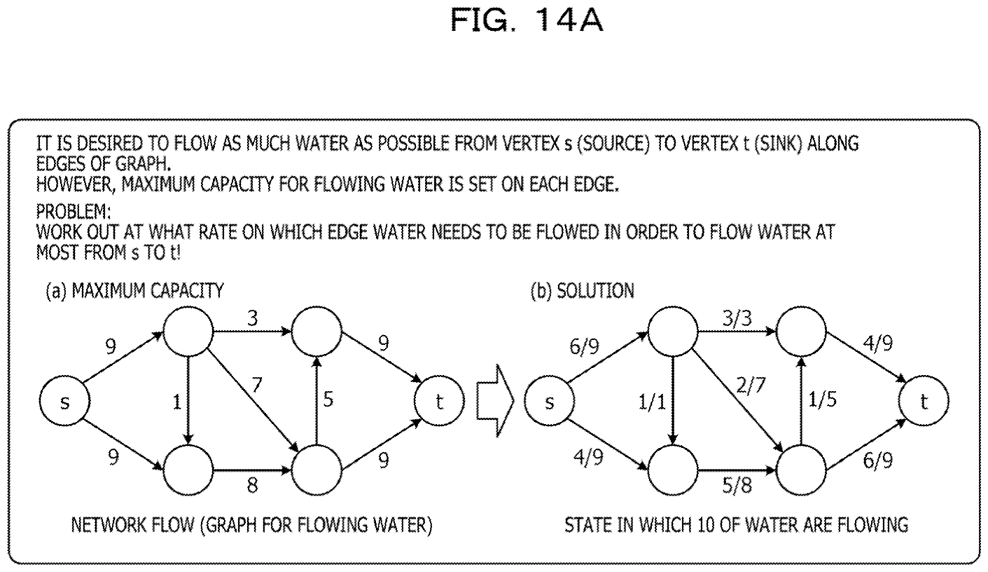

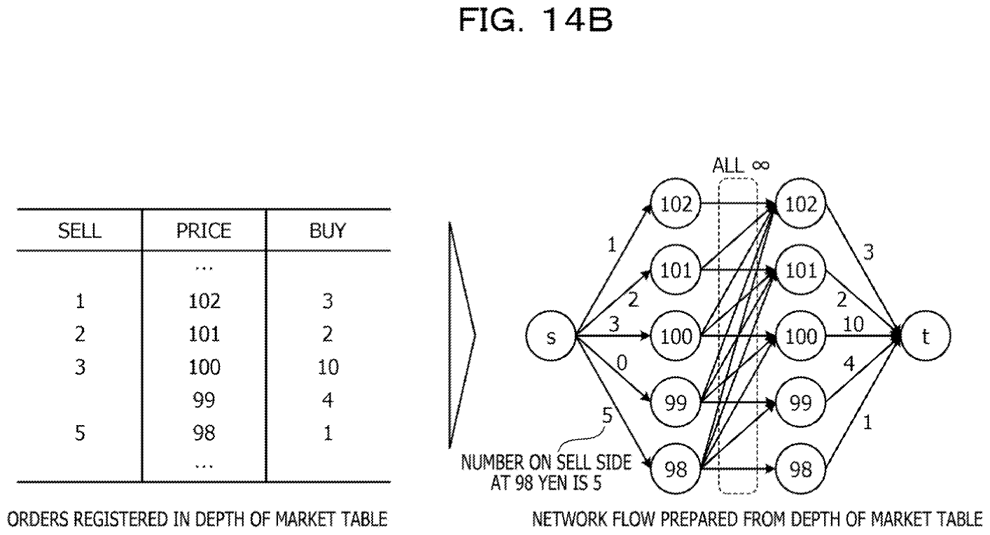

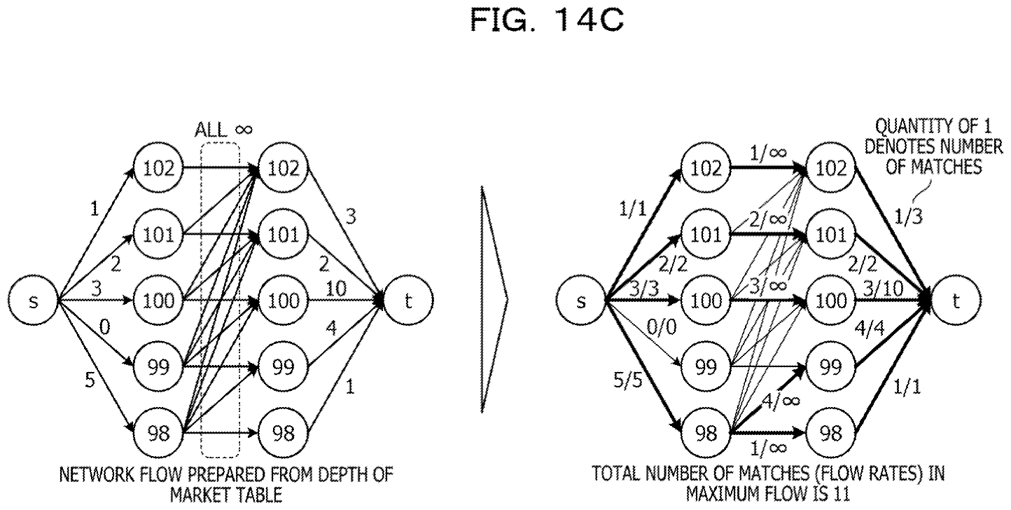

In the fifth matching method, the matching unit 22 performs matching that maximizes the number of matches by formulating the depth of market table as a network flow. FIG. 14A is a diagram for explaining a maximum flow problem for a network flow. As illustrated in FIG. 14A, the maximum flow problem is a problem to work out at what rate on which edge of the graph water needs to be flowed in order to flow as much water as possible from a vertex s (source) to a vertex t (sink) along the edges. However, as illustrate in (a) of FIG. 14A, the maximum capacity for flowing water is set on each edge. In FIG. 14A, (b) illustrates a solution where the fraction near each edge denotes the capacity in the denominator and the flow rate in the numerator. In (b) of FIG. 14A, 10 of water flows from s to t at maximum.

FIG. 14B is a diagram for explaining the formulation of the depth of market table as a network flow. As illustrated in FIG. 14B, the matching unit 22 creates vertices according to s (source), t (sink), the sell limits, and the buy limits. Then, the matching unit 22 designates the capacities between the sell vertices and the buy vertices as ∞ (no restriction), designates the capacity of an edge from s to a sell vertex as the number of sell orders with the sell limit of the sell vertex, and designates the capacity of an edge from a buy vertex to t as the number of buy orders with the buy limit of the buy vertex.

In FIG. 14B, the capacity of an edge from s to the sell vertex of 98 yen is five, the capacity of an edge from s to the sell vertex of 99 yen is zero, and the capacity of an edge from s to the sell vertex of 100 yen is three. Furthermore, the capacity of an edge from s to the sell vertex of 101 yen is two, and the capacity of an edge from s to the sell vertex of 102 yen is one.

Similarly, the capacity of an edge from the buy vertex of 98 yen to t is one, the capacity of an edge from the buy vertex of 99 yen to t is four, and the capacity of an edge from the buy vertex of 100 yen to t is ten. Furthermore, the capacity of an edge from the buy vertex of 101 yen to t is two, and the capacity of an edge from the buy vertex of 102 yen to t is three.

FIG. 14C is a diagram illustrating the maximum flow of the network flow illustrated in FIG. 148. In FIG. 14C, the flow rate on each edge indicates the number of matches, and the total number of matches is 11. For example, a total of 11 matches are performed, which is made up of a match between one sell at 98 yen and one buy at 98 yen, a match between four sells at 98 yen and four buys at 99 yen, a match between three sells at 100 yen and three buys at 100 yen, a match between two sells at 101 yen and two buys at 101 yen, and a match between one sell at 102 yen and one buy at 102 yen.

The matching unit 22 uses algorithms such as Hopcroft-Karp algorithm, Dinic algorithm, and Edmonds-Karp algorithm as algorithms for solving the maximum flow problem. Assuming that the number of vertices is V and the number of edges is E, the calculation amount of Hopcroft-Karp algorithm is O(E√V), the calculation amount of Dinic algorithm is O(V²E), and the calculation amount of Edmonds-Karp algorithm is O(VE²).

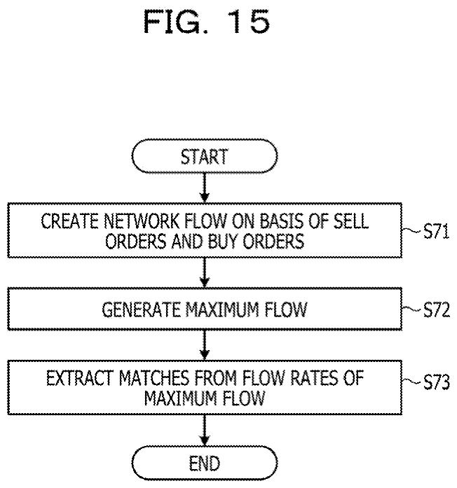

FIG. 15 is a flowchart illustrating a flow of processing by the fifth matching method. As illustrated in FIG. 15, the matching unit 22 creates a network flow on the basis of sell orders and buy orders (step S71). Then, the matching unit 22 generates the maximum flow (step S72) and extracts matches from the flow rates of the maximum flow (step S73).

In this manner, the matching unit 22 may specify matching with the maximum number of matches by formulating the depth of market table as a network flow.

As described above, in the first embodiment, the acquisition unit 21 of the execution device 13 acquires information on sell orders and buy orders for each brand from the order management device 12. Then, the matching unit 22 matches the sell orders and the buy orders. At this time, the matching unit 22 performs matching regardless of the present price if the limit price or a price more favorable to the investor than the limit price is given. Then, the execution price resolution unit 31 resolves the execution price for each match, based on the matching by the matching unit 22. Consequently, the execution device 13 may increase the number of executions in Itayose.

Furthermore, in the embodiment, since the matching unit 22 performs a full search, the sell orders and the buy orders may be matched.

In addition, in the embodiment, since the matching unit 22 randomly selects and matches the sell order and the buy order, the sell orders and the buy orders may be matched.

In addition, in the embodiment, since the matching unit 22 performs pruning in the search for matching, the optimum matching may be efficiently specified.

In addition, in the embodiment, since the matching unit 22 performs matching using a genetic algorithm, matching having excellent characteristics may be specified.

In addition, in the embodiment, since the matching unit 22 performs matching by formulating the depth of market table as a network flow, matching with the maximum number of matches may be specified.

### Second Embodiment

Incidentally, in the matching between the sell orders and the buy orders, when an order with an unfavorable price remains, the order constituting a matching pair may be replaced with an order with a more favorable price. Here, the favorable price represents a low price in the sell order and represents a high price in the buy order. An order with a favorable price is preferentially executed.

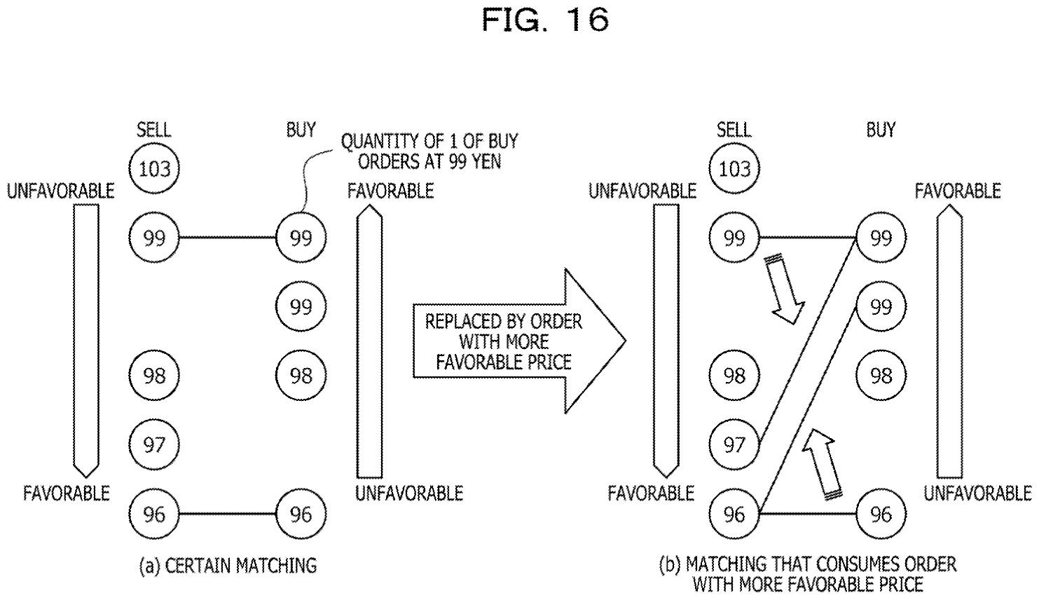

FIG. 16 is a diagram illustrating an example of replacing an order with an unfavorable price with an order with a more favorable price. In FIG. 16, (a) illustrates certain matching, and (b) of FIG. 16 illustrates matching that consumes an order with a more favorable price. In the matching illustrated in (a) of FIG. 16, there is a match between one sell at 96 yen and one buy at 96 yen and a match between one sell at 99 yen and one buy at 99 yen.

These two matches are replaced by matches at more favorable prices by replacing a sell order with a lower sell order and a buy order with a higher buy order, as illustrated in (b) of FIG. 16. For example, the match between one sell at 96 yen and one buy at 96 yen is replaced with a match between one sell at 96 yen and one buy at 99 yen, and the match between one sell at 99 yen and one buy at 99 yen is replaced with a match between one sell at 97 yen and one buy at 99 yen.

This means that, if the maximum number of executions k that allows matching can be specified, matching that completely consumes the favorable prices can be specified. Thus, in the second embodiment, a matching unit 22 that first specifies k and resolves matching between sell orders and buy orders after specifying k will be described.

The matching unit 22 according to the second embodiment matches all the sell orders from the lowest one. A buy order as the matching partner for a sell order at s yen is designated as a minimum buy order equal to or higher than s yen. Then, the matching unit 22 according to the second embodiment designates k as the number of matches when the buy orders have been exhausted and matching is no longer possible. Thereafter, the matching unit 22 according to the second embodiment shifts the buy orders to k from the highest one.

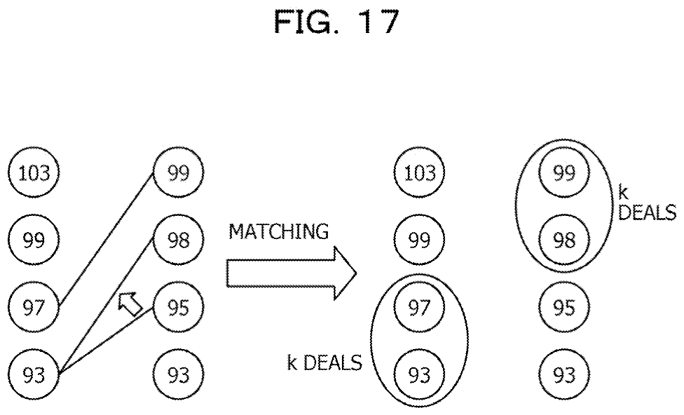

FIG. 17 is a diagram illustrating an example in which buy orders are shifted to k from the highest one. In FIG. 17, k=2 holds, and one buy at 95 yen matched with one sell at 93 yen is shifted to one buy at 98 yen.

The matching unit 22 according to the second embodiment specifies k using a binary search. For example, when l deals are matched and r (>l) deals are not matched, the matching unit 22 according to the second embodiment subsequently determines whether or not (l+r)/2 deals are matched. Then, the matching unit 22 according to the second embodiment subsequently replaces l with (l+r)/2 when the matching holds and replaces r with (l+r)/2 when the matching does not hold. By repeating such processing until l and r become consecutive numbers, the matching unit 22 according to the second embodiment specifies k.

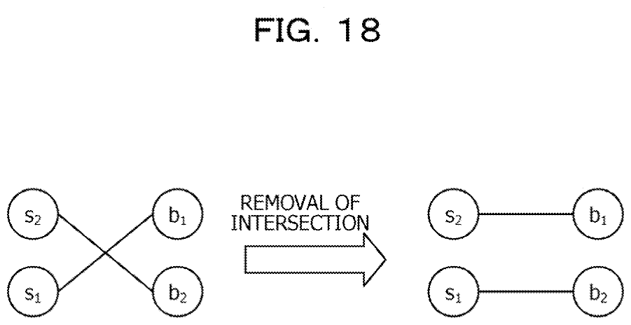

Note that the matching unit 22 according to the second embodiment removes an intersection. FIG. 18 is a diagram for explaining the removal of an intersection. The intersection means a case where there are two matches of a match between a sell at s₁ yen and a buy at b₁ yen and a match between a sell at s₂ yen and a buy at b₂ yen, and s₁≤s₂ and b₁≥b₂ hold. When there is such an intersection, the matching unit 22 removes the intersection by altering the two matches to a match between the sell at s₁ yen and the buy at b₂ yen and a match between the sell at s₂ yen and the buy at b₁ yen.

In order to enable the removal of the intersection illustrated in FIG. 18, it is sufficient that the matching establishment conditions s₂≤b₁ and s₁≤b₂ after the removal of the intersection are satisfied. Since s₁≤b₁ and s₂≤b₂ hold from the matching establishment conditions before the removal, s₂≤b₂≤b₁ and s₁≤s₂≤b₂ are satisfied, and s₁≤s₂≤b₂≤b₁ is satisfied. This means that s₂≤b₁ and s₁≤b₂ are satisfied.

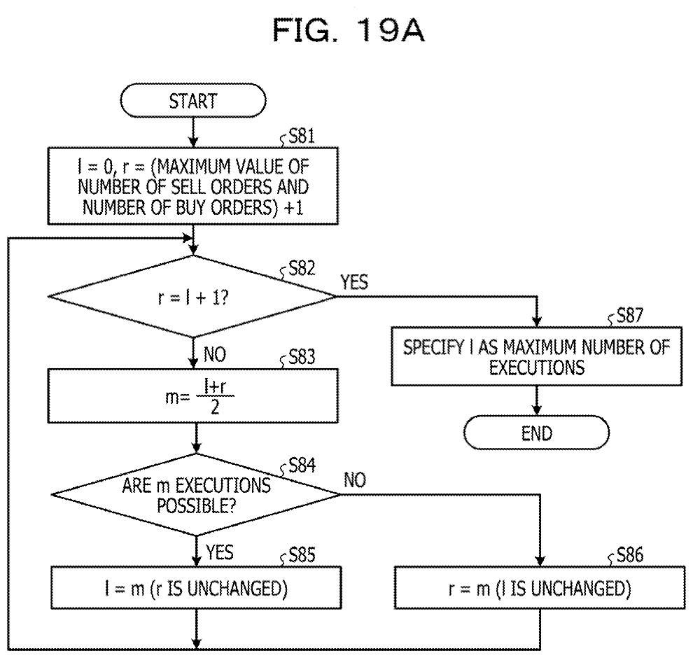

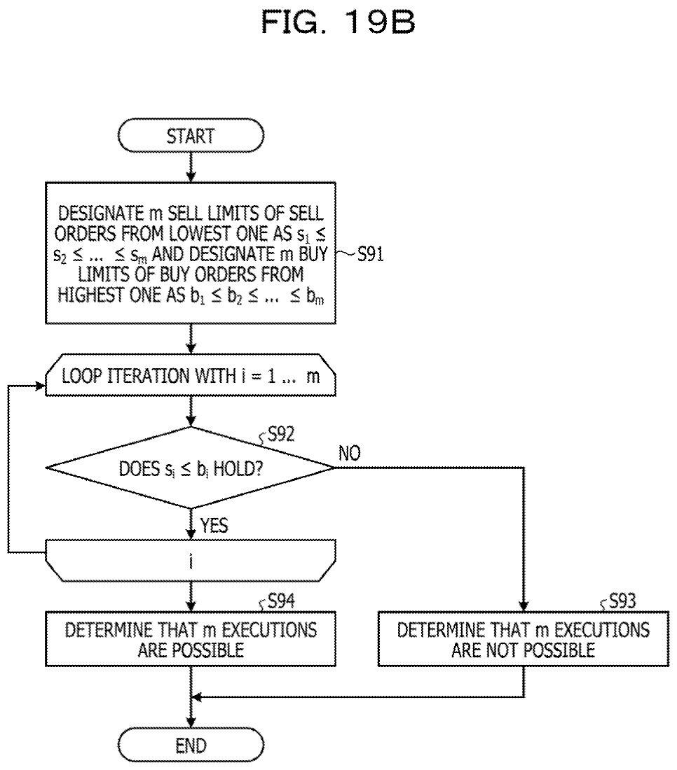

FIG. 19A is a flowchart illustrating a flow of processing in which the matching unit 22 according to a second embodiment specifies the maximum number of executions. As illustrated in FIG. 19A, the matching unit 22 according to the second embodiment designates l=0 and r=(the maximum value of the number of sell orders and the number of buy orders)+1 (step S81).

Then, the matching unit 22 according to the second embodiment determines whether or not r and l+1 are equal to each other (step S82) and, when r and l+1 are not equal to each other, designates m=(l+r)/2 (step S83). Then, the matching unit 22 according to the second embodiment determines whether or not m executions are possible (step S84) and, when m executions are possible, replaces the value of l with m (step S85), while replacing the value of r with m (step S86) when m executions are not possible. Thereafter, the matching unit 22 according to the second embodiment returns to step S82.

Furthermore, in step S82, when r and l+1 are equal to each other, the matching unit 22 according to the second embodiment specifies l as the maximum number of executions (step S87).

FIG. 19B is a flowchart illustrating a flow of processing in which it is determined whether or not m executions are possible. The matching unit 22 according to the second embodiment designates m sell limits of sell orders from the lowest one as s₁≤s₂≤ . . . ≤sₘ and designates m buy limits of buy orders from the highest one as b₁≤b₂≤ . . . ≤bₘ (step S91).

Then, the matching unit 22 according to the second embodiment repeats the processing of determining whether or not sᵢ is equal to or less than bᵢ (step S92) while incrementing i by one from one, and determines that m executions are not possible (step S93) when finding i whose sᵢ is not equal to or less than bᵢ. On the other hand, when sᵢ is equal to or less than bᵢ even if i is incremented to m, the matching unit 22 according to the second embodiment determines that m executions are possible (step S94).

As described above, since the matching unit 22 according to the second embodiment specifies the maximum number of executions using the binary search, the maximum number of executions may be efficiently specified.

As described above, the matching unit 22 according to the second embodiment specifies the maximum number of executions k using the binary search. Then, the matching unit 22 according to the second embodiment extracts sell orders by the maximum number of executions in the order from the lowest and extracts buy orders by the maximum number of executions in the order from the highest to match the extracted sell orders and buy orders in the order from the lowest. Consequently, the matching unit 22 according to the second embodiment may match and execute sell orders and buy orders at high speed.

### Third Embodiment

Although the maximum number of executions k is specified using the binary search, in a third embodiment, the matching unit 22 may specify the maximum number of executions k using a bipartite graph. Thus, a matching unit 22 that specifies the maximum number of executions k using a bipartite graph will be described.

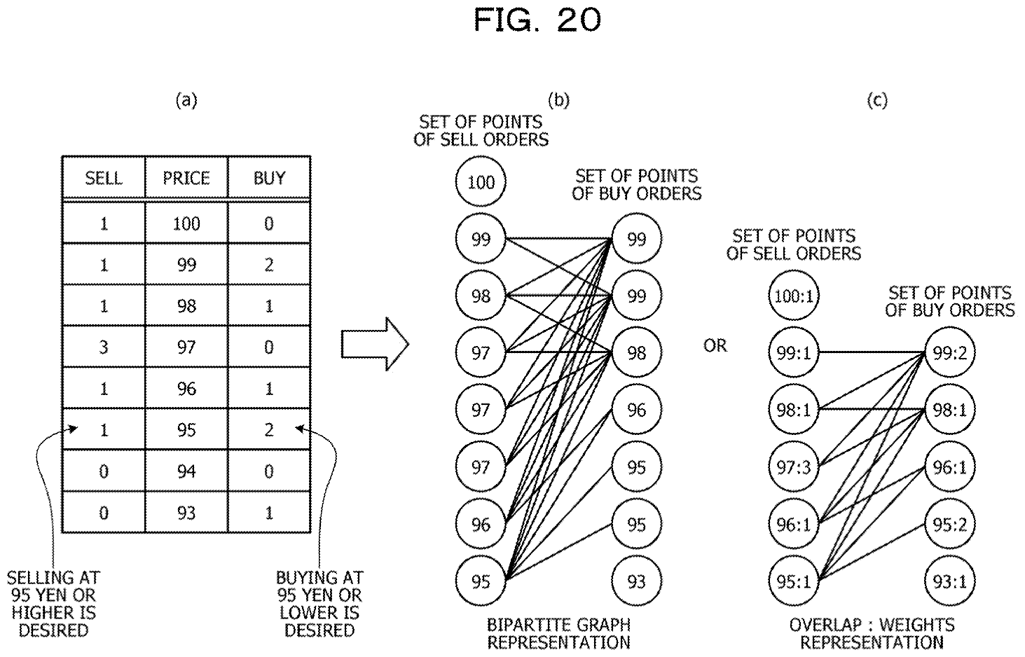

FIG. 20 is a diagram for explaining a bipartite graph representation of stock trading. In FIG. 20, (a) illustrates an example of the depth of market table, (b) of FIG. 20 illustrates a bipartite graph representation of (a) of FIG. 20, and (c) of FIG. 20 illustrates a case where the overlap of limit prices is represented by weights.

As illustrated in (b) of FIG. 20, the bipartite graph representation of stock trading is made up of a set of vertices indicating the sell limits and a set of vertices indicating the buy limits. Furthermore, in the bipartite graph representation of stock trading, an edge exists only between vertices where the sell limit≤the buy limit hold.

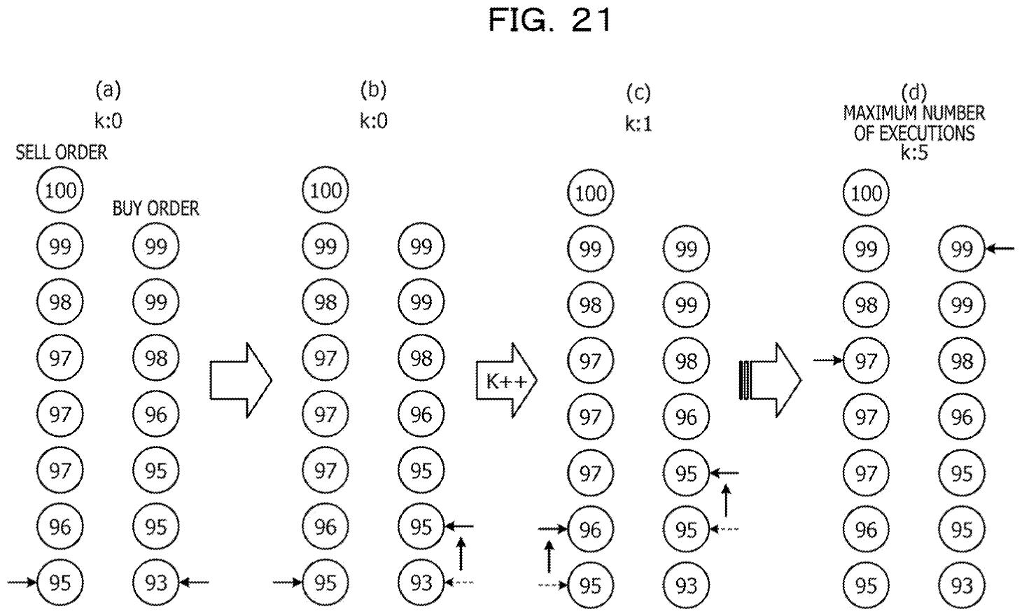

The matching unit 22 according to the third embodiment specifies the maximum value of the number of vertex pairs as the maximum number of executions k when selecting a vertex pair sharing the edge from the respective sets of vertices such that the vertices do not overlap. FIG. 21 is a diagram for explaining a method of specifying the maximum number of executions k.

The matching unit 22 according to the third embodiment starts with vertices indicating the lowest prices of the sell order and the buy order and repeats processing of advancing the vertices until the vertex of the sell order or the buy order disappears, to specify the maximum number of executions k. In the processing of advancing the vertices, the matching unit 22 according to the third embodiment compares the sell limit and the buy limit and advances the vertex of the buy order when the sell limit>the buy limit hold, while incrementing the value of k by +1 and advancing the vertices of both of the orders when the sell limit≤the buy limit hold. Note that the initial value of k is zero.

As illustrated in (a) of FIG. 21, the matching unit 22 according to the third embodiment starts the processing of advancing the vertices from a sell at 95 yen and a buy at 93 yen. Then, the matching unit 22 according to the third embodiment compares the sell limit of 95 yen and the buy limit of 93 yen and, since the sell limit>the buy limit hold, advances the vertex of the buy order to designate the vertex of the buy order as the buy at 95 yen as illustrated in (b) of FIG. 21.

Thereafter, the matching unit 22 according to the third embodiment compares the sell limit of 95 yen and the buy limit of 95 yen. Since the sell limit the buy limit hold, the matching unit 22 increments the value of k by 1 and advances the vertices of both of the orders to designate the vertex of the sell order as the sell at 96 yen and the vertex of the buy order as the subsequent buy at 95 yen as illustrated in (c) of FIG. 21. By repeating similar processing, as illustrated in (d) of FIG. 21, the vertex of the buy order disappears, and the matching unit 22 according to the third embodiment specifies k=5.

Then, the matching unit 22 according to the third embodiment extracts k vertices of the sell orders in the order from the lowest sell limit and extracts k vertices of the buy order in the order from the highest buy limit. Thereafter, the matching unit 22 according to the third embodiment specifies maximum matching that meets a priority by creating the vertex pairs in the order from the smallest limit price. Here, the lower the sell limit, the higher the priority, and the higher the buy limit, the higher the priority.

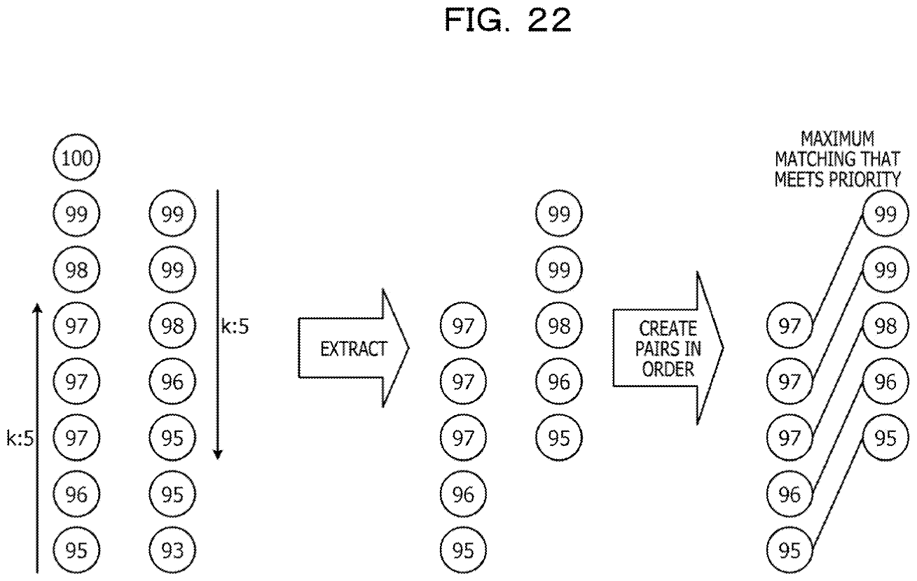

FIG. 22 is a diagram illustrating maximum matching that meets the priority. As illustrated in FIG. 22, five vertices of sell orders are extracted from 95 yen to 97 yen in the order from the lowest, and five vertices of buy orders are extracted from 99 yen to 95 yen in the order from the highest. Then, five vertex pairs are created in the order from the smallest limit price, which are namely a vertex pair of the sell limit of 95 yen and the buy limit of 95 yen, a vertex pair of the sell limit of 96 yen and the buy limit of 96 yen, a vertex pair of the sell limit of 97 yen and the buy limit of 98 yen, a vertex pair of the sell limit of 97 yen and the buy limit of 99 yen, and a vertex pair of the sell limit of 97 yen and the buy limit of 99 yen.

Returning to (c) of FIG. 20, when the overlap of limit prices is represented by weights, the bipartite graph representation is made up of a set of vertices indicating sell limits and weights and a set of vertices indicating buy limits and weights. Also in this case, an edge exists only between vertices where the sell limit≤the buy limit hold.

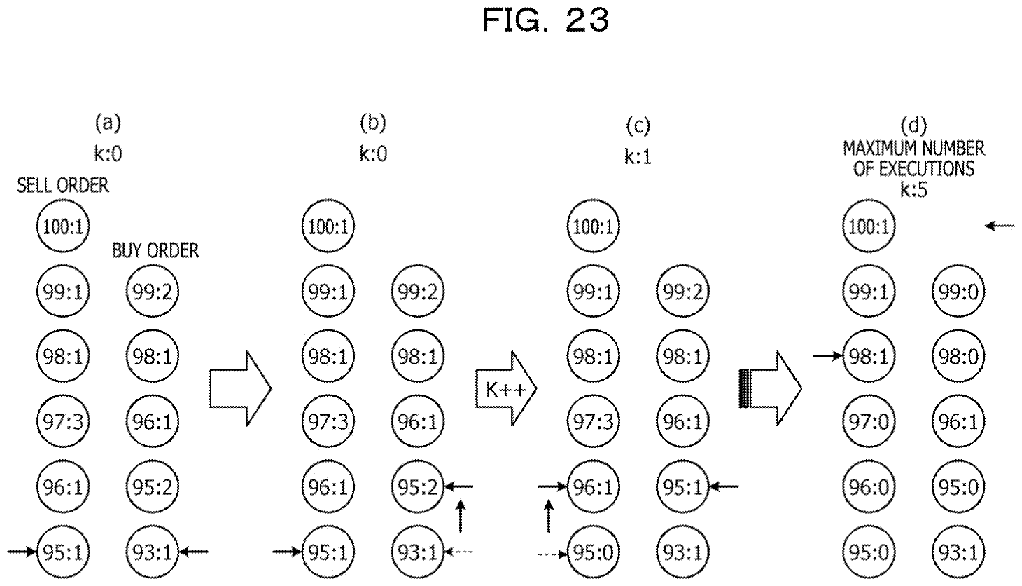

The matching unit 22 according to the third embodiment specifies the maximum value of the number of vertex pairs as the maximum number of executions k when selecting a vertex pair sharing the edge from the respective sets of vertices such that the overlap of the vertices is equal to or less than the weight. FIG. 23 is a diagram for explaining a method of specifying the maximum number of executions k.

The matching unit 22 according to the third embodiment starts with vertices indicating the lowest prices of the sell order and the buy order and repeats processing of advancing the vertices until the vertex of the sell order or the buy order disappears, to specify the maximum number of executions k. In the processing of advancing the vertices, the matching unit 22 according to the third embodiment compares the sell limit and the buy limit and advances the vertex of the buy order when the sell limit >the buy limit hold, while incrementing the value of k by +1 and decrementing the weights of both by −1 when the sell limit≤the buy limit hold, and advancing the vertices of the orders when the weights become zero. Note that the initial value of k is zero.

As illustrated in (a) of FIG. 23, the matching unit 22 according to the third embodiment starts the processing of advancing the vertices from a sell at 95 yen and a buy at 93 yen. Then, the matching unit 22 according to the third embodiment compares the sell limit of 95 yen and the buy limit of 93 yen and, since the sell limit>the buy limit hold, advances the vertex of the buy order to designate the vertex of the buy order as the buy at 95 yen as illustrated in (b) of FIG. 23.

Then, the matching unit 22 according to the third embodiment compares the sell limit of 95 yen and the buy limit of 95 yen. Since the sell limit≤the buy limit hold, the matching unit 22 increments the value of k by +1 and decrements the weights of both by −1. In consequence, since the weight of the sell limit of 95 yen becomes zero, the matching unit 22 according to the third embodiment advances the vertex of the sell order and, as illustrated in (c) of FIG. 23, designates the vertex of the sell order as the sell at 96 yen. By repeating similar processing, as illustrated in (d) of FIG. 23, the vertex of the buy order disappears, and the matching unit 22 according to the third embodiment specifies k=5.

Then, the matching unit 22 according to the third embodiment extracts the vertices of sell orders in the order from the lowest sell limit such that the total weight becomes k, and extracts the vertices of buy orders in the order from the highest buy limit such that the total weight becomes k. Thereafter, the matching unit 22 according to the third embodiment specifies maximum matching that meets a priority by creating the vertex pairs under weight constraints in the order from the smallest limit price.

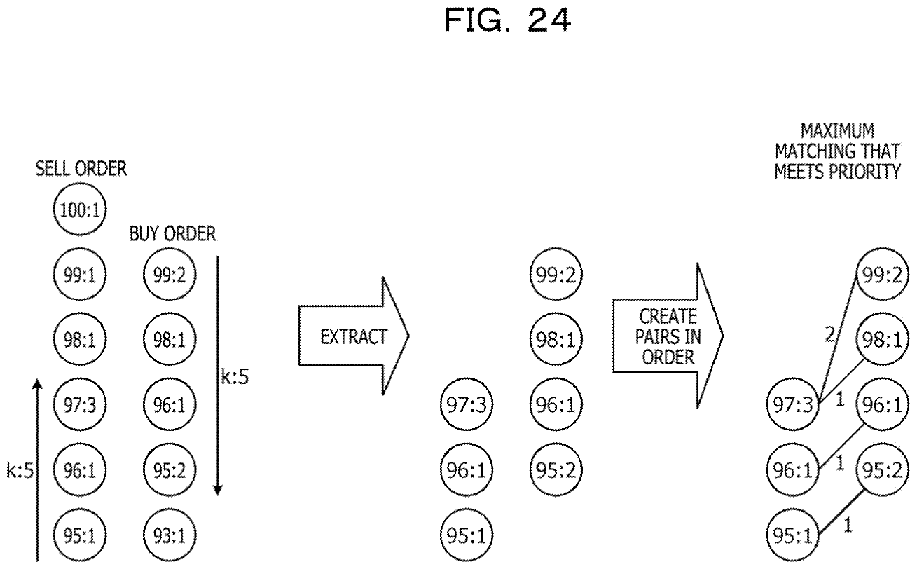

FIG. 24 is a diagram illustrating maximum matching that meets the priority. As illustrated in FIG. 24, three vertices of sell orders are extracted from 95 yen to 97 yen in the order from the lowest, and four vertices of buy orders are extracted from 99 yen to 95 yen in the order from the highest. Then, four vertex pairs are created in the order from the smallest limit price, which are namely a vertex pair of the sell limit of 95 yen and the buy limit of 95 yen, a vertex pair of the sell limit of 96 yen and the buy limit of 96 yen, a vertex pair of the sell limit of 97 yen and the buy limit of 98 yen, and a vertex pair of the sell limit of 97 yen and the buy limit of 99 yen. The weight of the vertex pair of the sell limit of 95 yen and the buy limit of 95 yen is one, the weight of the vertex pair of the sell limit of 96 yen and the buy limit of 96 yen is one, the weight of the vertex pair of the sell limit of 97 yen and the buy limit of 98 yen is one, and the weight of the vertex pair of the sell limit of 97 yen and the buy limit of 99 yen is two.

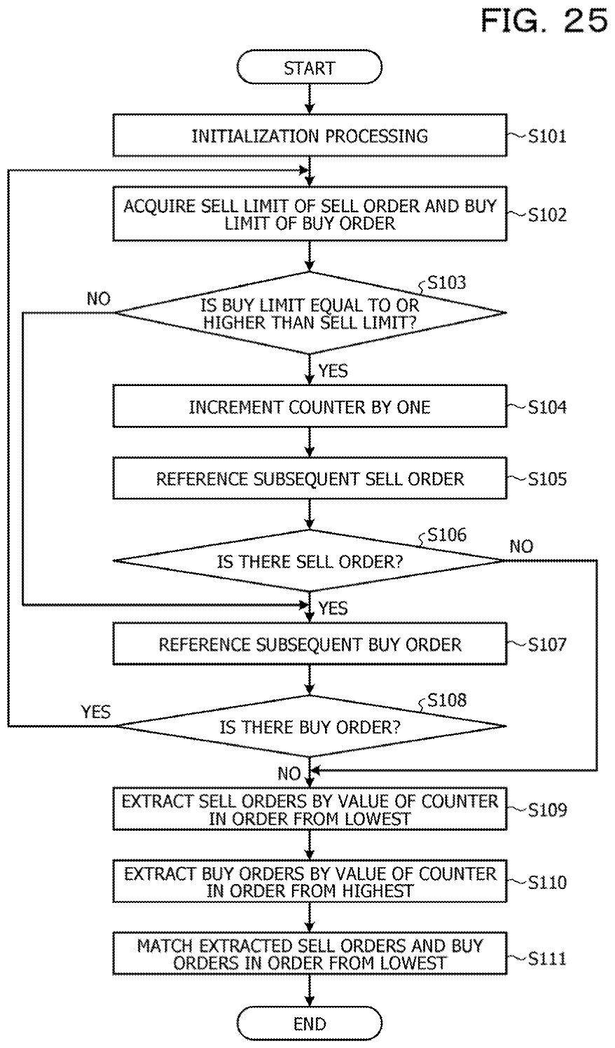

FIG. 25 is a flowchart illustrating a flow of processing by the matching unit 22 according to the third embodiment. As illustrated in FIG. 25, the matching unit 22 according to the third embodiment performs initialization processing (step S101). The initialization processing includes sorting by the limit prices of sell orders, sorting by the limit prices of buy orders, and the initialization of a counter (the value is designated as zero).

Then, the matching unit 22 according to the third embodiment acquires the sell limit of the sell order and the buy limit of the buy order (step S102). Here, the matching unit 22 according to the third embodiment acquires the limit prices of the currently referenced orders. At the beginning, an order with the lowest sell limit and an order with the lowest buy limit are referenced.

Thereafter, the matching unit 22 according to the third embodiment determines whether or not the buy limit is equal to or higher than the sell limit (step S103) and, when the buy limit is not equal to or higher than the sell limit, proceeds to step S107. On the other hand, when the buy limit is equal to or higher than the sell limit, the matching unit 22 according to the third embodiment increments the counter by one (step S104) and references the subsequent sell order (step S105).

Then, the matching unit 22 according to the third embodiment determines whether or not there is a sell order (step S106) and proceeds to step S109 when there is no sell order, while referencing the subsequent buy order (step S107) when there is a sell order. Thereafter, the matching unit 22 according to the third embodiment determines whether or not there is a buy order (step S108) and, when there is a buy order, returns to step S102.

On the other hand, when there is no buy order, the matching unit 22 according to the third embodiment extracts sell orders by the value of the counter in the order from the lowest (step S109) and extracts buy orders by the value of the counter in the order from the highest (step S110). Then, the matching unit 22 according to the third embodiment matches the extracted sell orders and buy orders in the order from the lowest (step S111).

In this manner, the matching unit 22 according to the third embodiment specifies the maximum number of executions using the counter to extract sell orders by the maximum number of executions in the order from the lowest and to extract buy orders by the maximum number of executions in the order from the highest, and matches the extracted sell orders and buy orders in the order from the lowest. Consequently, the matching unit 22 according to the third embodiment may match sell orders and buy orders at high speed.

The calculation amount of an ordinary maximum matching algorithm for the bipartite graph is O(EV), but the calculation amount of matching by the matching unit 22 according to the third embodiment is O(V).

Here, E denotes the number of edges, and V denotes the number of vertices. Furthermore, although the priority is not allowed to be included in the ordinary maximum matching algorithm for the bipartite graph, the priority may be included in matching by the matching unit 22 according to the third embodiment,

As described above, the matching unit 22 according to the third embodiment references the sell orders and the buy orders in the order from the lowest ones until either the sell order or the buy order disappears, and counts the number of sell limits equal to or lower than the buy limits to specify the maximum number of executions. Therefore, the maximum number of executions may be specified at high speed.

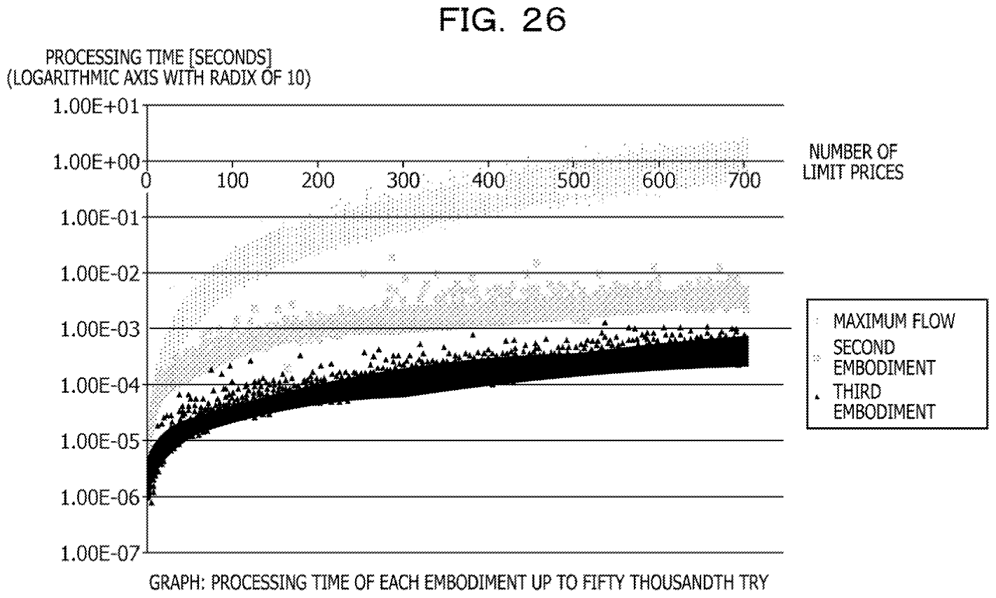

FIG. 26 is a diagram illustrating an example of processing time by the matching units 22 according to the first to third embodiments. In the first embodiment, the fifth matching method is used. The horizontal axis denotes the number of limit prices. The vertical axis denotes the processing time (seconds), which is a logarithmic axis having a radix of 10. As illustrated in FIG. 26, the processing time of the matching unit 22 according to the third embodiment is the shortest, and the processing time of the matching unit 22 according to the second embodiment is the next shortest.

Note that, in the first to third embodiments, the execution device 13 has been described. However, by implementing the components included in the execution device 13 by software, an execution program that has a similar function may be obtained. Thus, a computer that executes the execution program will be described.

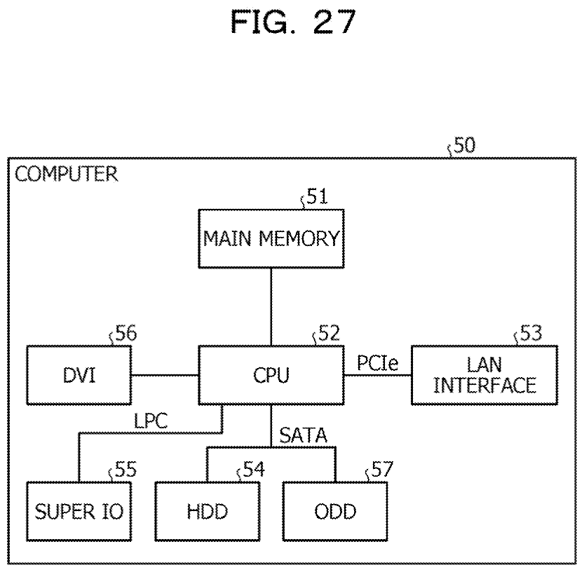

FIG. 27 is a diagram illustrating a hardware configuration of a computer that executes the execution program according to an embodiment. As illustrated in FIG. 27, a computer 50 includes a main memory 51, a central processing unit (CPU) 52, a local area network (LAN) interface 53, and a hard disk drive (HDD) 54. Furthermore, the computer 50 includes a super input output (IO) 55, a digital visual interface (DVI) 56, and an optical disk drive (ODD) 57.

The main memory 51 is a memory that stores a program, a halfway result of execution of the program, and the like. The CPU 52 is a central processing unit that reads and executes a program from the main memory 51. The CPU 52 includes a chipset having a memory controller.

The LAN interface 53 is an interface for connecting the computer 50 to another computer by way of a LAN. The HDD 54 is a disk device that stores a program and data, and the super IO 55 is an interface for connecting an input device such as a mouse and a keyboard. The DVI 56 is an interface that connects a liquid crystal display device, and the ODD 57 is a device that performs reading and writing on a digital versatile disk (DVD),

The LAN interface 53 is connected to the CPU 52 by peripheral component interconnect express (PCIe), and the HDD 54 and the ODD 57 are connected to the CPU 52 by serial advanced technology attachment (SATA). The super IO 55 is connected to the CPU 52 by low pin count (LPC).

Then, the execution program executed by the computer 50 is stored in a DVD that is an example of a recording medium that can be read by the computer 50, and is read from the DVD by the ODD 57 to be installed to the computer 50. Alternatively, the execution program is stored in a database or the like of another computer system connected via the LAN interface 53 and is read from the above database or the like to be installed to the computer 50. Then, the installed execution program is stored in the HDD 54, read to the main memory 51, and executed by the CPU 52.

Furthermore, in the embodiments, a case where the trading system 1 includes the acceptance device 11, the order management device 12, and the execution device 13 has been described. However, the functions of the acceptance device 11, the order management device 12, and the execution device 13 may be integrated into one and configured as the trading device. Alternatively, any two functions may be integrated into one, for example, the functions of the acceptance device 11 and the order management device 12 may be integrated into one, and formed as one device.

Furthermore, in the embodiments, the case of trading stocks has been described, but the trading system 1 may trade other securities and articles.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a trading program
for causing a computer to execute a process comprising:
acquiring a number of sell orders for each of sell limits and a number of buy orders for each of buy limits;
executing one of pairings of one of the sell orders and one of the buy orders in which one of the sell limits of the one of the sell orders is equal to or lower than one of the buy limits of the one of the buy orders, among the pairings of the sell orders and the buy orders, based on the acquired number of the sell orders for each of the sell limits and the acquired number of the buy orders for each of the buy limits; and
resolving an execution price for each of executions.

2. The non-transitory computer-readable recording medium storing the trading program according to claim 1, wherein the executing includes executing the sell orders and the buy orders by performing a full search regarding numbers of the executions and combinations between the sell orders and the buy orders at each of the numbers of the executions.

3. The non-transitory computer-readable recording medium storing the trading program according to claim 1, wherein the executing includes executing the sell orders and the buy orders while performing a full search regarding numbers of the executions and making random selection regarding combinations between the sell orders and the buy orders.

4. The non-transitory computer-readable recording medium storing the trading program according to claim 1, wherein the executing includes executing the sell orders and the buy order while performing pruning using branch and bound.

5. The non-transitory computer-readable recording medium storing the trading program according to claim 1, wherein the executing includes executing the sell orders and the buy orders by using a genetic algorithm with a set that has one or more combinations between the sell orders and the buy orders as one generation.

6. The non-transitory computer-readable recording medium storing the trading program according to claim 1, wherein the executing includes executing by calculating a flow rate of each of edges when water that is flowed from a source to a sink is maximized in a network in which each of the sell limits is designated as a sell vertex, each of the buy limits is designated as a buy vertex, a capacity of one of the edges from the source to the sell vertex is designated as a number of sell orders with one of the sell limits of the sell vertex, a capacity of one of the edges from the buy vertex to the sink is designated as a number of orders with one of the buy limits of the buy vertex, and a capacity of one of the edges between the sell vertex and the buy vertex is designated as infinite.

7. The non-transitory computer-readable recording medium storing the trading program according to claim 1, wherein the executing includes specifying a maximum number of the executions, extracting the sell orders by the maximum number of the executions in an order from lowest, extracting the buy orders by the maximum number of the executions in an order from highest, and executing the extracted sell orders and buy orders in an order from lowest.

8. The non-transitory computer-readable recording medium storing the trading program according to claim 7, wherein the specifying the maximum number of the executions includes specifying the maximum number of the executions using a binary search.

9. The non-transitory computer-readable recording medium storing the trading program according to claim 7, wherein the specifying the maximum number of the executions includes referencing the sell orders and the buy orders in an order from lowest ones until either the sell orders or the buy orders disappear, and counting a number of some of the sell limits equal to or lower than the buy limits to specify the maximum number of the executions.

10. A trading method comprising:
acquiring a number of sell orders for each of sell limits and a number of buy orders for each of buy limits;
executing one of pairings of one of the sell orders and one of the buy orders in which one of the sell limits of the one of the sell orders is equal to or lower than one of the buy limits of the one of the buy orders, among the pairings of the sell orders and the buy orders, based on the acquired number of the sell orders for each of the sell limits and the acquired number of the buy orders for each of the buy limits; and
resolving an execution price for each of executions.

11. The trading method according to claim 10, wherein the executing includes executing by calculating a flow rate of each of edges when water that is flowed from a source to a sink is maximized in a network in which each of the sell limits is designated as a sell vertex, each of the buy limits is designated as a buy vertex, a capacity of one of the edges from the source to the sell vertex is designated as a number of sell orders with one of the sell limits of the sell vertex, a capacity of one of the edges from the buy vertex to the sink is designated as a number of orders with one of the buy limits of the buy vertex, and a capacity of one of the edges between the sell vertex and the buy vertex is designated as infinite.

12. The trading method according to claim 10, wherein the executing includes specifying a maximum number of the executions, extracting the sell orders by the maximum number of the executions in an order from lowest, extracting the buy orders by the maximum number of the executions in an order from highest, and executing the extracted sell orders and buy orders in an order from lowest.

13. An information processing device comprising:
a memory; and
a processor coupled to the memory and configured to:
acquire a number of sell orders for each of sell limits and a number of buy orders for each of buy limits;
execute one of pairings of one of the sell orders and one of the buy orders in which one of the sell limits of the one of the sell orders is equal to or lower than one of the buy limits of the one of the buy orders, among the pairings of the sell orders and the buy orders, based on the acquired number of the sell orders for each of the sell limits and the acquired number of the buy orders for each of the buy limits; and
resolve an execution price for each of executions.

14. The information processing device according to claim 13, wherein the processor executes by calculating a flow rate of each of edges when water that is flowed from a source to a sink is maximized in a network in which each of the sell limits is designated as a sell vertex, each of the buy limits is designated as a buy vertex, a capacity of one of the edges from the source to the sell vertex is designated as a number of sell orders with one of the sell limits of the sell vertex, a capacity of one of the edges from the buy vertex to the sink is designated as a number of orders with one of the buy limits of the buy vertex, and a capacity of one of the edges between the sell vertex and the buy vertex is designated as infinite.

15. The information processing device according to claim 13, wherein the processor specifies a maximum number of the executions, extracts the sell orders by the maximum number of the executions in an order from lowest, extracts the buy orders by the maximum number of the executions in an order from highest, and executes the extracted sell orders and buy orders in an order from lowest.
